(19) United States
(12) Patent Application Publication
(10) Pub. No.: US 2007/0210065 A1
(43) Pub. Date: Sep. 13, 2007

(54) HEATING UNIT

(75) Inventors: Sang Bum SOHN, Seoul (KR); Seung Jo BAEK, Gyeonggi-do (KR); Byeong Wook PARK, Gyeonggi-do (KR); Sung Bae SONG, Gyeonggi-do (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/678,843

(22) Filed: Feb. 26, 2007

(30) Foreign Application Priority Data
Feb. 27, 2006 (KR) 10-2006-0018875

(51) Int. Cl. H05B 3/68

(52) U.S. Cl. 219/460.1

(57) ABSTRACT

A heating unit includes a heater that generates radiant heat, and a reflector that reflects radiant heat generated by the heater toward an object. The reflector includes a side portion shaped as an involute, a central elevated portion of a predetermined height, and a connecting portion that connects the side portion to the elevated portion. A supporter supports the heater in a position spaced from the reflector by a predetermined distance.

This application claims the benefit of the Patent Korean Application No. 10-2006-0018875, filed on Feb. 27, 2006, which is hereby incorporated by reference in its entirety.

### BACKGROUND OF THE INVENTION

1. Field of the Invention

The present invention relates to a heating unit having a reflection member for reflecting radiant heat generated from a heat source. More particularly, the present invention relates to a heating unit that can uniformly transfer radiant heat to an object to be heated, while preventing the radiant heat reflected by the reflection member from being transferred back to a heat source.

2. Description of the Related Art

Generally, a cook top is an environmentally friendly appliance which allows a user to cook in a clean and pleasant environment without consumption of oxygen and exhaustion of carbon oxide. In addition, the cook top is an energy-saving appliance as it can quickly reach a peak heating power utilizing a heating source made of a new material and maintain a predetermined temperature using a temperature sensor.

A typical heating unit applied to a conventional cook top includes a base defining an outer appearance, a heat source radiating high temperature radiant heat, a ceramic plate that is provided above the base and on which cooking pans or bowls are located, and a reflecting member for reflecting the radiant heat radiated from the heat source to the ceramic plate.

During operation of a conventional cook top, when electric power is applied to the heat source and the heat source radiates the radiant heat, a part of the radiant heat is directly transferred to the ceramic plate and the remainder of the radiant heat is reflected by a reflecting member to the ceramic plate. Then, a pan or bowl located on the ceramic plate is heated by the radiant heat transferred to the ceramic plate, and the foodstuff contained in the pan or bowl is cooked.

However, during operation of the conventional heating unit, a portion of the radiant heat radiated from the heat source is transferred back to the heat source by the reflecting member which increases an internal temperature of the heat source. This may cause damage to the heat source.

In addition, since some of the radiant heat is transferred back to the heat source, the effective radiation of the heat source is reduced, which reduces the efficiency of the heat source.

Further, since the radiant heat reflected by the reflecting member is not uniformly transferred to the ceramic plate, uniform heating of the foodstuff cannot be realized and thus effective cooking cannot be achieved.

### SUMMARY OF THE INVENTION

Accordingly, the present invention is directed to a heating unit that avoids the above-noted problems.

An object of the present invention is to provide a heating unit that can prevent reflected radiant heat from being transferred back to a heat source by improving a shape of a reflecting member, thereby preventing damage to the heat source.

Another object of the present invention is to provide a heating unit that can uniformly transfer radiant heat radiated from a heat source to an object to be heated.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a heating unit includes a heater that generates radiant heat; and a reflector configured to reflect radiant heat generated by the heater toward an object, the reflector including a side portion shaped as an involute.

The reflector may further include a central elevated portion of a predetermined height. The height of the elevated portion may be greater than the height of a center of the heater. The elevated portion may have a circular top. The elevated portion may extend linearly from a lower end to an upper end.

The reflector may further include a horizontal portion that connects the side portion to the elevated portion. The horizontal portion may extend along a common tangent line of an involute defined outwardly with reference to a center of a circle having a diameter greater than a diameter of the heater and an involute defined inwardly with reference to the center of the circle. The side portion may have the shape of the outwardly defined involute. The elevated portion may extend linearly from the horizontal portion. The elevated portion may be inclined by substantially 10° with respect to the horizontal portion. The horizontal portion may be positioned below the heater.

A vertical distance between a top of the reflector and a center of the heater may be substantially the same as a radius of the heater. The involute shape of the side portion may be defined by a series of straight lines.

In another aspect of the present invention, a heating unit includes a heater that generates radiant heat; and a reflector configured to reflect radiant heat generated by the heater toward an object, the reflector including a side portion shaped as an involute, a central elevated portion of a predetermined height, and a connecting portion that connects the side portion to the elevated portion.

The connecting portion may extend substantially horizontally. The connecting portion may extend along a common tangent line of an involute defined outwardly with reference to a center of a circle having a diameter greater than a diameter of the heater and an involute defined inwardly with reference to the center of the circle. The side portion may have the shape of the outwardly defined involute. A radius of the circle may be substantially the same as the diameter of the heater. A top of the elevated portion may be higher than a center of the heater.

In another aspect of the present invention, a heating unit includes a heater that generates radiant heat; a reflector configured to reflect radiant heat generated by the heater toward an object; and a supporter configured to support the heater in a position spaced from the reflector by a predetermined distance. The heater has a circular section, and a portion of the reflector has a curvature corresponding to an involute defined by a circle having a diameter greater than the diameter of the circular section of the heater.

According to the present invention, since at least one side surface of the reflecting member is formed in an involute shape, the transferring of radiant heat reflected from the side surface to the heat source can be prevented.

Further, since transferring of radiant heat to the heat source is prevented, the deterioration of the effective radiation of the heat source is prevented and damage of the heat source due to the radiant heat is also prevented. As a result, the heat generation efficiency of the heat source is improved.

In addition, since the side surface of the reflecting member is formed in the involute shape, the reflecting member becomes compact.

Furthermore, since an elevated portion formed on a central portion of the reflecting member is higher than a center point of a cross-section of the heat source, interference between the radiant heat can be prevented.

In addition, since the radiant heat is uniformly incident on the plate, the uniform heating of the plate becomes possible and thus the cooking performance is improved.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a cook top provided with a heating unit according to an embodiment of the present invention;

FIG. 2 is a perspective view of a heating unit according to an embodiment of the present invention;

FIG. 3 is a sectional view taken along line I-I′ of FIG. 2;

FIG. 4 is a view illustrating a plotting method of an involute curve; and

FIG. 5 is a view illustrating a method of forming a reflecting member according to an embodiment of the present invention.

### DETAILED DESCRIPTION OF THE INVENTION

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art.

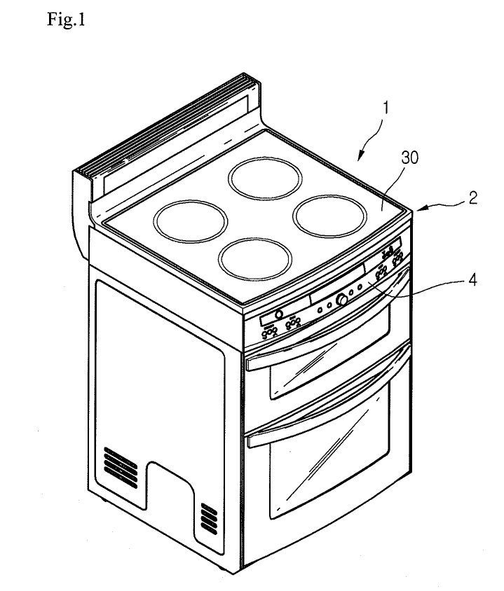

FIG. 1 is a perspective view of a cook top provided with a heating unit according to an embodiment of the present invention.

A cook top 1 of an embodiment of the present invention includes a base 2, an upper plate 30 disposed on an upper portion of the base 2, and a control unit 4 used for controlling operation of the cook top 1. A plurality of heating units, that will be described later, are provided in the base 2.

Accordingly, a cooking bowl or pan containing foodstuff to be cooked, is disposed on the upper plate 30. When the heating unit operates, the foodstuff is cooked.

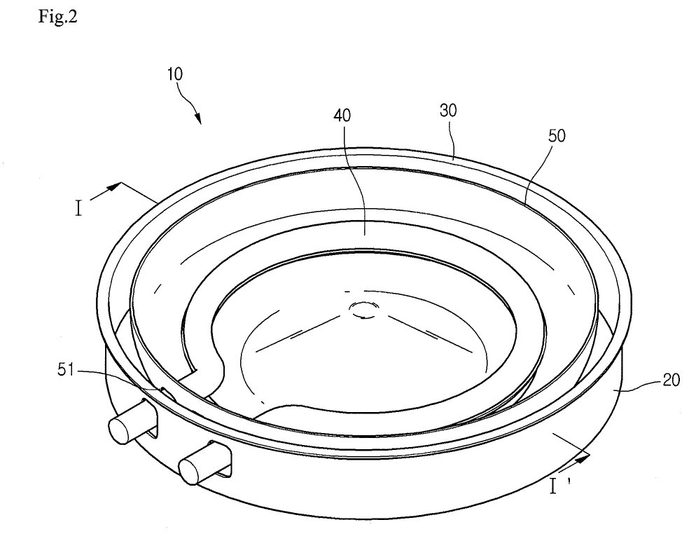

The following will describe a structure of the heating unit. FIG. 2 is a perspective view of a heating unit according to an embodiment of the present invention.

Referring to FIG. 2, the heat unit 10 according to an embodiment of the present invention includes a casing 20, a heater or heat source 40 that is provided in the casing 20 to heat the cooking bowl disposed on the upper plate 30 by radiating radiant heat, and a reflecting member 50 for reflecting the radiant heat radiated from the heat source 40 to the upper plate 30.

In more detail, the casing 20 has a concave inner portion having a predetermined depth. The casing 20 may be formed of an insulation material to prevent the radiant heat from being transferred externally of the casing.

The heat source 40 is formed in a substantially circular shape or a “Ω” shape. The heat source 40 may be of any suitable type, such as a halogen heater.

The reflecting member 50 is provided under the heat source 40 to reflect the radiant heat radiated from the heat source 40. The reflecting member 50 is provided with at least one through hole 51 through which the heat source 40 passes. The reflecting member 50 may be formed of any suitable material.

The following will briefly describe an operation of the above-described heating unit 10. When the cooking mode is selected by a user, electric power is applied to the heat source 40, so that the heat source 40 radiates the radiant heat. This radiant heat is directly transferred to the upper plate 30 or transferred to the upper plate 30 after being reflected by the reflecting member 50. The cooking bowl is heated by the radiant heat transferred to the upper plate 30 and in this manner the foodstuff contained in the cooking bowl is cooked.

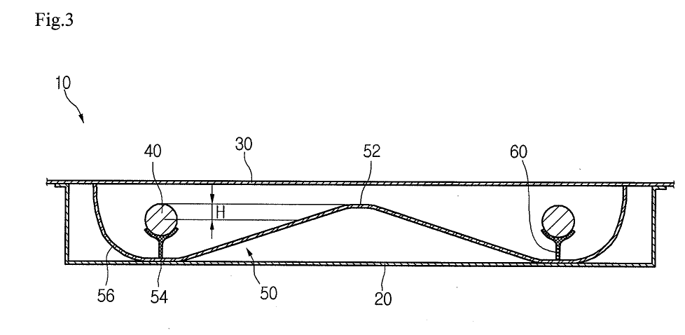

FIG. 3 is a sectional view taken along line I-I′ of FIG. 2.

Referring to FIG. 3, the heating unit 10 is provided internally with the heat source 40 that radiates radiant heat. The heat source 40 is spaced apart from the reflecting member 50 by a predetermined distance and supported by a supporting unit 60. The supporting unit may be formed in any suitable manner of any suitable material.

The reflecting member 50 includes an elevated portion 52 elevated from a central portion by a predetermined height, a horizontal portion 54 extending horizontally from the elevated portion 52, and a side portion 56 defining the side surface of the reflecting member 50 and formed in an involute shape.

The elevated portion 52 functions to reflect the radiant heat toward the central portion of the upper plate 30.

The elevated portion 52 is formed to be higher than a center point of the cross-section of the heat source 40 to prevent the interference between the radiant heat generated by different portions of the heat source 40.

That is, when a vertical distance between a top of the elevated portion 52 and a central point of a section of the heat source 40 is H, the following condition is satisfied: H>0. It is more desirable that the distance H is greater than a radius of the section of the heat source 40, as shown in FIG. 3.

If the reflecting member is not provided with the elevated portion, the radiant heat radiated horizontally from a side of the heat source may be transferred to another side of the heat source. As a result, the heat source may be damaged and the radiant heat may be not transferred to the central portion of the upper plate, which reduces the heating efficiency. Further, if the radiant heat is not transferred to the central portion of the upper plate, time to cook the foodstuff located on the upper plate increases and the cooking performance is deteriorated.

Therefore, according to this embodiment of the present invention, the elevated portion 52 is formed on the central portion of the reflecting member 50 so as to be higher than the center point of the cross-section of the heat source 40. This arrangement prevents the radiant heat radiated by different portions of the heat source 40 from interfering with each other, and facilitates the uniform transfer the radiant heat to the central portion of the upper plate 30.

As the radiant heat is uniformly transferred to the central portion of the upper plate 30 by the elevated portion 52, the time for cooking the foodstuff can be reduced and the cooking performance can be improved.

The top surface of the elevated portion 52 is rounded with a predetermined curvature. When viewed from above, the top surface of the elevated portion 52 is formed in a circular shape. A horizontal section of the elevated portion 52 is also formed in a circular shape.

A side surface of the elevated portion 52 extends linearly from an end portion of the horizontal portion 54 so as to effectively reflect the radiant heat and uniformly transfer the radiant heat to the upper plate 30.

The side portion 56 is formed in the involute shape so as to prevent the radiant heat reflected from being transferred back to the heat source 40. Further, since the side portion 56 of the reflecting member 50 is formed in the involute shape, the reflecting member 50 is more compact in the casing 20.

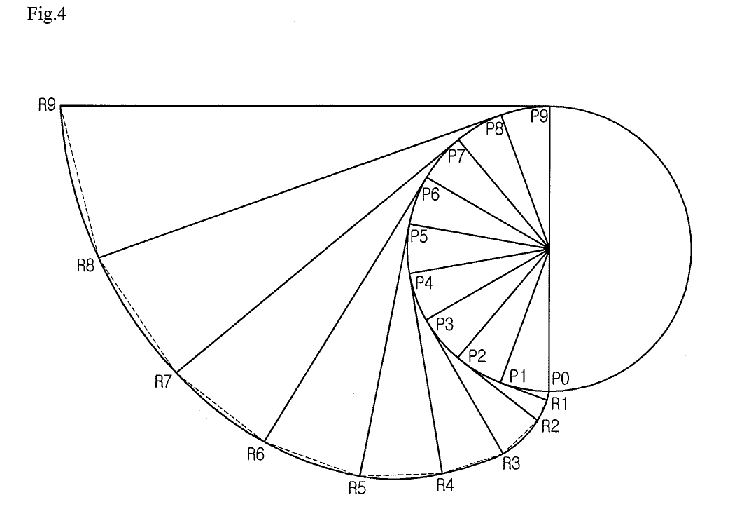

Following is description of a plotting method of an involute curve. FIG. 4 is a view illustrating a plotting method of an involute curve.

Referring to FIG. 4, the involute is shaped along a trace of an end point of a thread wound around a circle having a predetermined diameter. The circumference of the circle is identically divided at points P1, P2, P3, . . . , and Pn. Tangent lines of the respective points are drawn to respective lengths POP1, POP2, POP3, . . . , and POPn.

Next, end points of the respective tangent lines are assigned with R1, R1, R3, . . . , and Rn, after which the end points are connected along the trace of the end point of the thread, thereby completing the involute curve.

The diameter of the circle is designed to be about two times the diameter of the heat source 40 so as to prevent the radiant heat reflected by the reflecting member 50 from being transferred to the heat source 40. Accordingly, a distance between the center point of the heat source 40 and the center point of the upper plate 30 is the same as the diameter of the heat source 40 or the radius of the circle. Further, a radius of the involute curve defining the side portion 56 may vary in accordance with the diameter of the heat source 40.

In addition, the side portion 56 may be formed by a combination of straight lines rather than curves. That is, during the formation of the involute curve as shown by a dotted-line of FIG. 4, the end points R1, R1, R3, . . . , and Rn are connected by straight lines, the side portion 56 can be formed by the combination of the straight lines similar to the involute curve.

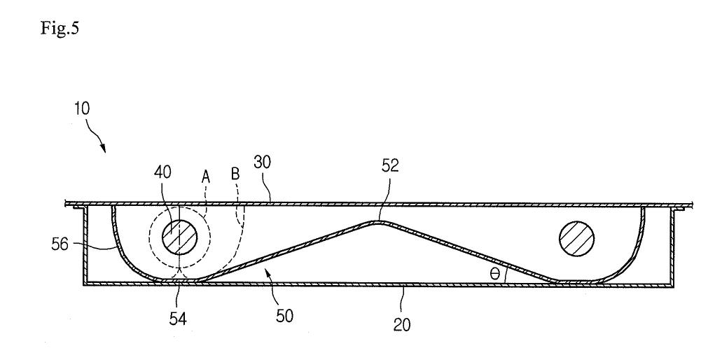

The following describes a method of forming the reflecting member according to the embodiment of the present invention with reference to the above-described involute curve plotting method. FIG. 5 is a view illustrating a method of forming the reflecting member according to an embodiment of the present invention.

As shown in FIG. 5, a circle (a dotted line A) having a diameter two times that of the heat source 40 is first drawn. Subsequently, an involute curve (the side portion) is drawn from a reference point of the circle A outwardly of the heat source 40, and an imaginary involute curve (a dotted line B) is drawn inwardly of the heat source 40.

A common tangent line of the two involute curves is drawn to complete the horizontal portion 54. Accordingly, it can be understood that the side portion 56 is a portion that is formed at an outer side with reference to a bottom point of the involute curve formed at an outer side. In this case, the side portion 56 will be formed at the outer side of the imaginary curve extending from the center point of the heat source 40.

Next, the elevated portion 52 is completed by drawing an inclined line from an end portion of the horizontal portion 54, i.e., from the bottom point of the imaginary involute curve toward the center of the reflecting member 50. Subsequently, when the top surface of the elevated portion 52 is formed to be straight or rounded, the reflecting member 50 is completed.

Here, an angle θ between the horizontal portion 54 and the elevated portion 52 may be about 10° so that the radiant heat reflected by the elevated portion 52 can be transferred to the upper plate 30. In FIG. 5, a state where the angle is greater than 10° is illustrated by way of example.

The following describes an operation of the heating unit 10.

First, electric power is applied to the heat source 40. Then, the heat source 40 radiates the radiant heat. A part of the radiant heat is directly transferred to the upper plate 30 and the rest of the radiant heat is reflected by the reflecting member 50 and is then transferred to the upper plate 30.

In more detail, the radiant heat radiated to an outer side from the center of the horizontal portion 54 is reflected to the upper plate located at an outer side with reference to the heat source 40.

Accordingly, as the side portion 56 of the reflecting member 50 is formed in the involute shape, the transferring of the radiant heat reflected from the side portion 56 to the heat source 40 can be prevented. Therefore, damage to the heat source 40 can be prevented and the heat generation efficiency of the heat source 40 can be improved.

Further, since the side portion 56 is formed in the involute shape and the central portion of the reflecting member 50 is higher than the center of the cross-section of the heat source 40, the radiant heat can be uniformly transferred to the upper plate 30. The uniform transferring of the radiant heat to the upper plate 30 improves the cooking performance.

It will be apparent to those skilled in the art that various modifications and variations can be made in the present invention. Thus, it is intended that the present invention covers such modifications and variations of the invention.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to exemplary embodiments, it is understood that the words that have been used are words of description and illustration, rather than words of limitation. As the present invention may be embodied in several forms without departing from the spirit or essential characteristics thereof, it should also be understood that the above-described embodiment is not limited by any of the details of the foregoing description, unless otherwise specified. Rather, the above-described embodiment should be construed broadly within the spirit and scope of the present invention as defined in the appended claims. Therefore, changes may be made within the metes and bounds of the appended claims, as presently stated and as amended, without departing from the scope and spirit of the invention in its aspects.

What is claimed is:

1. A heating unit comprising:
a heater that generates radiant heat; and
a reflector configured to reflect radiant heat generated by the heater toward an object, the reflector including a side portion shaped as an involute.

2. The heating unit according to claim 1, the reflector further including a central elevated portion of a predetermined height.

3. The heating unit according to claim 2, wherein the height of the elevated portion is greater than the height of a center of the heater.

4. The heating unit according to claim 2, wherein the elevated portion has a circular top.

5. The heating unit according to claim 2, wherein the elevated portion extends linearly from a lower end to an upper end.

6. The heating unit according to claim 2, the reflector further including a horizontal portion that connects the side portion to the elevated portion.

7. The heating unit according to claim 6, wherein the horizontal portion extends along a common tangent line of an involute defined outwardly with reference to a center of a circle having a diameter greater than a diameter of the heater and an involute defined inwardly with reference to the center of the circle.

8. The heating unit according to claim 7, wherein the side portion has the shape of the outwardly defined involute.

9. The heating unit according to claim 6, wherein the elevated portion extends linearly from the horizontal portion.

10. The heating unit according to claim 6, wherein the elevated portion is inclined by substantially 10° with respect to the horizontal portion.

11. The heating unit according to claim 6, wherein the horizontal portion is positioned below the heater.

12. The heating unit according to claim 1, wherein a vertical distance between a top of the reflector and a center of the heater is substantially the same as a radius of the heater.

13. The heating unit according to claim 1, wherein the involute shape of the side portion is defined by a series of straight lines.

14. A heating unit comprising:
a heater that generates radiant heat; and
a reflector configured to reflect radiant heat generated by the heater toward an object, the reflector including a side portion shaped as an involute, a central elevated portion of a predetermined height, and a connecting portion that connects the side portion to the elevated portion.

15. The heating unit according to claim 14, wherein the connecting portion extends substantially horizontally.

16. The heating unit according to claim 14, wherein the connecting portion extends along a common tangent line of an involute defined outwardly with reference to a center of a circle having a diameter greater than a diameter of the heater and an involute defined inwardly with reference to the center of the circle.

17. The heating unit according to claim 16, wherein the side portion has the shape of the outwardly defined involute.

18. The heating unit according to claim 16, wherein a radius of the circle is substantially the same as the diameter of the heater.

19. The heating unit according to claim 14, wherein a top of the elevated portion is higher than a center of the heater.

20. A heating unit comprising:
a heater that generates radiant heat;
a reflector configured to reflect radiant heat generated by the heater toward an object; and
a supporter configured to support the heater in a position spaced from the reflector by a predetermined distance,
wherein the heater has a circular section, a portion of the reflector having a curvature corresponding to an involute defined by a circle having a diameter greater than the diameter of the circular section of the heater.
